(19) United States
(12) Patent Application Publication
(10) Pub. No.: US 2020/0317242 A1
(43) Pub. Date: Oct. 8, 2020

(54) METHOD OF CREATING A TRANSIT SCHEDULE

(71) Applicant: William Entriken, Huntingdon Valley, PA (US)

(72) Inventor: William Entriken, Huntingdon Valley, PA (US)

(73) Assignee: William Entriken, Huntingdon Valley, PA (US)

(21) Appl. No.: 16/374,934

(22) Filed: Apr. 4, 2019

(51) Int. Cl. B61L 27/00; G08G 1/127; G06F 16/953

(52) U.S. Cl. CPC B61L 27/0016; B61L 27/0022; G06Q 50/30; G06F 16/953; G08G 1/127

(57) ABSTRACT

A method of generating an improved transit schedule is described that incorporates real-time arrival time data, such as actual minutes of lateness for each stop for each train in a train transit district. Lateness data is collected over a time period, such as a year. After sorting the collected arrival times for each stop for each route, the list is sorted for ascending lateness. A performance percentage is used to select a time from the list such that the performance percentage of trips would have been on time. This is a proposed arrival time for a new timetable. Finally, a change threshold is applied so that changes below the threshold, such as two minutes, are left the same as on the initial schedule. The final new timetable is published or printed, or otherwise made available.

### BACKGROUND OF THE INVENTION

Transportation timetables, such as train schedules, bus schedules and flight schedules, are typically created by the associated transit agency using models to compute an estimated transit time between stops. The models are often complex, considering factors such as distance, type of road or rail, time of day, time of year, day of week, typical weather, expected traffic, equipment to be used, and the like, etc. This approach suffers from two weaknesses. First, this modeling approach often does not produce an accurate schedule. For example, one particular train may typically run 20 minutes late from this a planned model-based schedule. As another example, one particular fight might typically arrive 20 minutes early. Prior art schedules may be viewed as “planned” performance. A second weakness is that modeling generally assumes that equipment is ready at the planned departure time. However, in many cases the equipment arrives late, as an incoming train or plane may be delayed. That is, planned timetables do not take into account variations in arrival time of equipment. Prior art includes modifying a planned arrival time for a single trip, using real-time data.

### SUMMARY OF THE INVENTION

Embodiments of this invention overcome weaknesses of prior art.

Some prior art focuses on updating a single arrival time for an individual route and stop based on a current, that is, real-time, location/time of a vehicle, typically generating a single, updated “expected arrival time.” Other prior art focuses on having a human scheduler adjust for real-time vehicle activity, such as trains passing each other to change one-time arrival times of specific vehicles. Such updates are of minimal use for passengers and connections because it does not allow for advance planning by those parties.

The problem solved by embodiments of this invention is to create a new, more accurate, fixed schedule based on comprehensive, actual, historical data from an operational transit system that was operating on a previous, fixed schedule.

Often, data about actual operating performance, that is, exact departure and arrival times, for every route and stop, after the fact, are publicly available. The first step is to collect, acquire, or download this data, which is often available on a web site of the transit agency, or via a standardized transit stop feed, such as “Google Generated Transit Feed Specification,” or “General Transit Feed Specification,” or GTFS. We also refer to an initial schedule as “existing,” or a “planned” schedule.

The next step is to continually “scrape” a website to extract actual arrival times. Again this is for every stop for every route, or a selected subset. Although we refer to a “website,” such a data source may be an alternative source, such as an app (application on a personal electronic device, or similar), or a data feed (such as an RSS or GTFS feed). Although initial schedules are usually provide by the transit agency directly, sometimes actual arrival times are provide by a third party. This data needs to be explicitly or implicitly show routes and stops identification. By “routes,” we mean a regularly scheduled, identified trip. For train, “train numbers” are used. For buses, a “bus number” is used, although sometimes bus routes are named, instead of numbered. For airlines, flight numbers are the route identification. Service types may be explicit or implicit, as are AM/PM, Inbound/Outbound identification and day of week, for example.

Such web (“initial”) schedule data for all routes and stops for the entire transit fleet, or a selected subset. This is typically done for a time period such as one year, although the time period may be different.

In a first embodiment, the second step is to time-sort the historical arrival times for each stop for each route. Then a “cut-off” in the sorted list is selected based on a desired on-time percentage, such as, “98% of trains will arrive by this time.”

In a second embodiment, the next step is a statistical analysis of each route or trip number, such as a bus route, train number, or flight number, for each station. In a third step, new arrival times, and optionally new departure times, are computed from the statistical analysis that shows “likely” performance, rather than “planned” performance. New arrival times may be computed for a particular statistical likelihood, such as, “98% of trains will arrive by this time.”

The set of newly computed times, for all routes and stops considered, is then published, on paper or electronically, as a new timetable or schedule. Note that schedules typically include additional information beyond a timetable that includes transit number, stop and arrival time. For example, they typically include type of service, which may include special services, such as trains with bicycle cars, or extra busses for major events, as examples.

An alternative embodiment is to provide a range or “time bracket”, such as “90% of trains arrive between this time and that time.” Yet another embodiment has two ranges, a first is “typical,” or “usually,” that might include 75% to 90% of historical arrivals. Also, a “nearly always” time or time bracket that might include 98% or 99% of historical arrival times.

A new or improved timetable or schedule may be printed on paper, posted on boards, displayed on electronic signs, available on web sites, available on apps running on personal electronics, or available for other processing, such as a trip planner, social media site, a navigation service or device, or autonomous vehicles.

Note that in many cases one arrival time affects a subsequent departure time. For example, for many bus and train times, the equipment must first arrive at a station, than shortly depart after a dwell time for unloading and loading. If a train is 20 minutes late arriving, it may also be 20 minutes late departing.

Transit types applicable to embodiments with regularly schedule transit, including: trains, busses, aircraft, ships, cruises, tours, tourist trips or events, space flights, employee shuttles with schedules, and the like. Embodiments only apply to these modes of transportation if they are regularly scheduled, with routes and stops identified, with initial schedule and real-time data available electronically: autonomous vehicle trips, personal bicycle and scooter rentals, car rentals, taxis, space flights, drone flights, and ride sharing services.

### BRIEF DESCRIPTION OF THE DRAWINGS

FIG. 1 shows method steps in an exemplary embodiment.

FIG. 2 shows a portion of a typical timetable.

FIG. 3 shows a typical printed train timetable.

FIG. 4 shows a portion of a typical transit agency web page.

FIG. 5 shows a portion of minutes-late graph, for one stop.

FIG. 6 shows a first of three pages of exemplary code.

FIG. 7 shows a second of three pages of exemplary code.

FIG. 8 shows a third of three pages of exemplary code.

### DETAILED DESCRIPTION

Scenarios and options are non-limiting embodiments.

The technical problem to solve is: creating accurate, new transit timetables for a route and stops, based on historical performance.

Collecting data on actual, historical performance of transit agency trips is non-trivial. One method is to look at real-time data of individual trips. This information is continually updated, but only shows “current” trips. Thus, any such web site must be continually monitored in order to collect data on all trips. This is an interactive, on-going process, as typically information, such as a flight number or train number, must be entered into the web site before it will display time data about that trip. An app on a personal electronic device, such as a smart phone, smart watch, tablet, personal computer, virtual reality or augmented reality screen, or heads-up display, is for the purposes of this patent application, also a web site.

For convenience we refer to any organization with a responsibility for a schedule or operation to be a, “transit agency.” Such an agency may or may not be the same agency that owns or operates the equipment. We refer to a, “transit vehicle,” as any vehicle that operates to the schedule. It may be a bus, train or plane, for example. In some case, rather than a traditional transit agency, another identifier for a group of routes may be used. For example, instead of, “United Airlines,” we might use, “all flights out of SFO airport.” We refer to a, “route,” as any identified regular trip with one or more stops. It might be a bus number, train number of flight number, as examples. We refer to a, “transit stop,” as any location associated with an arrival or departure time on a schedule. We refer to a, “fixed schedule,” as a timetable that is generally repeated for each time the route is traveled, as compared, for example, to one-time prediction for one particular vehicle for one particular stop, typically in the future, such as an updated expected arrival time for a single flight on the same day. We refer to an, “analysis period,” as a time period when real-time data is scraped, collected, acquired, aggregated, or harvested.

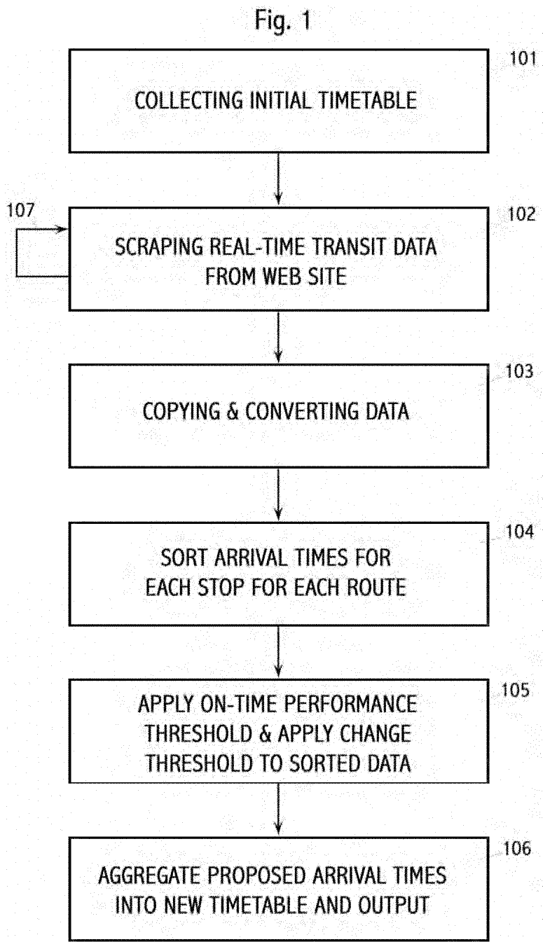

Please refer now to claim 1 and FIG. 1.

A first step includes determining a source and format of electronic schedule data for an existing public schedule, and identifying any data conversion necessary to process that data. We refer to this as a fixed schedule, or initial schedule, retrieval protocol. This step includes acquiring and converting this current, fixed-schedule data. We refer to this data as an initial timetable, which may be placed in a database or other non-volatile, convenient electronic storage. See claim 1(a) or 101 in FIG. 1.

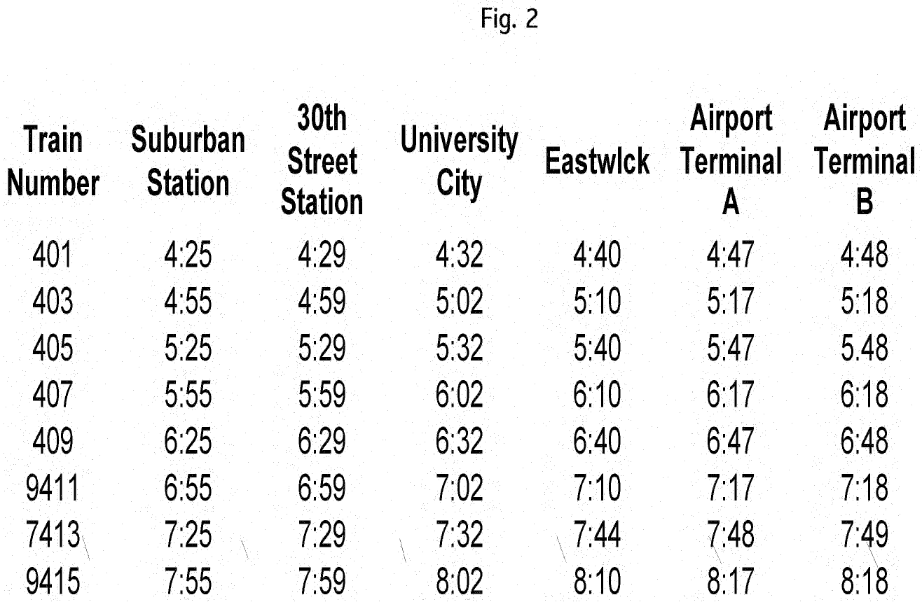

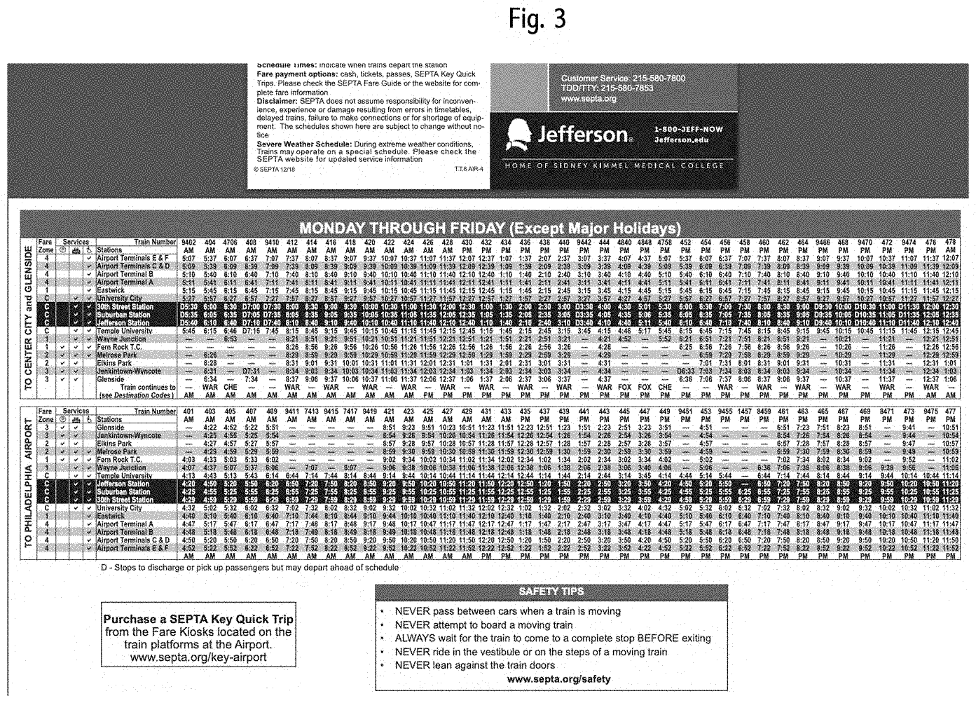

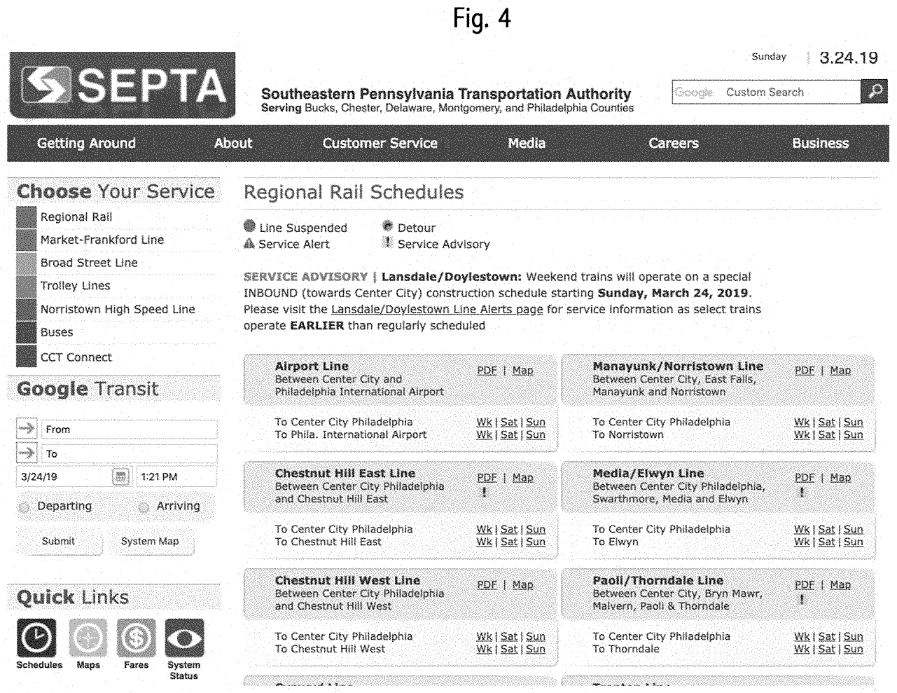

Often, data about actual operating performance, that is, exact departure and arrival times, for every route and stop, after the fact, are publicly available. The first step is to collect, acquire, or download this data, which is often available on a web site of the transit agency, or via a standardized transit stop feed, such as “Google Generated Transit Feed Specification,” or “General Transit Feed Specification,” or GTFS. GTFS data may be available as a single file. If necessary data could be keyed or OCR generated from a printed schedule, such as shown in FIG. 3. At a minimum, this data would have stop locations and stop times, such as shown in FIG. 2. This Figure does not show transit numbers, such as train numbers. These transit numbers would either be part of the data, or would be known separately, such as in a file name, or in a query string, or as a choice of which link to “click” on a schedule web site, such as shown in FIG. 4. Although a full schedule typically has “service type,” such as express train, first class seating, bicycle cars, and the like, service types do not need to be explicitly in timetables or schedules. Stops may be coded as numbers, names, (“strings”) or other identification of a specific, physical location. Times may be encoded as numbers, text strings, or other identification that is clearly a time of day when properly interpreted. See FIG. 2. This figure does not show AM or PM information, or a day of week, or service type. Again, this information would either be in the data formally, or would otherwise be clearly known either before, during or after data collection or download. Although we talk about arrival times, all times herein also apply to departure times. For example, for trains, it is arrival time that is most often shown in a printed schedule, while for airlines it is departure time that is considered most relevant to passengers. We also refer to an initial schedule as “existing,” or a “planned” schedule.

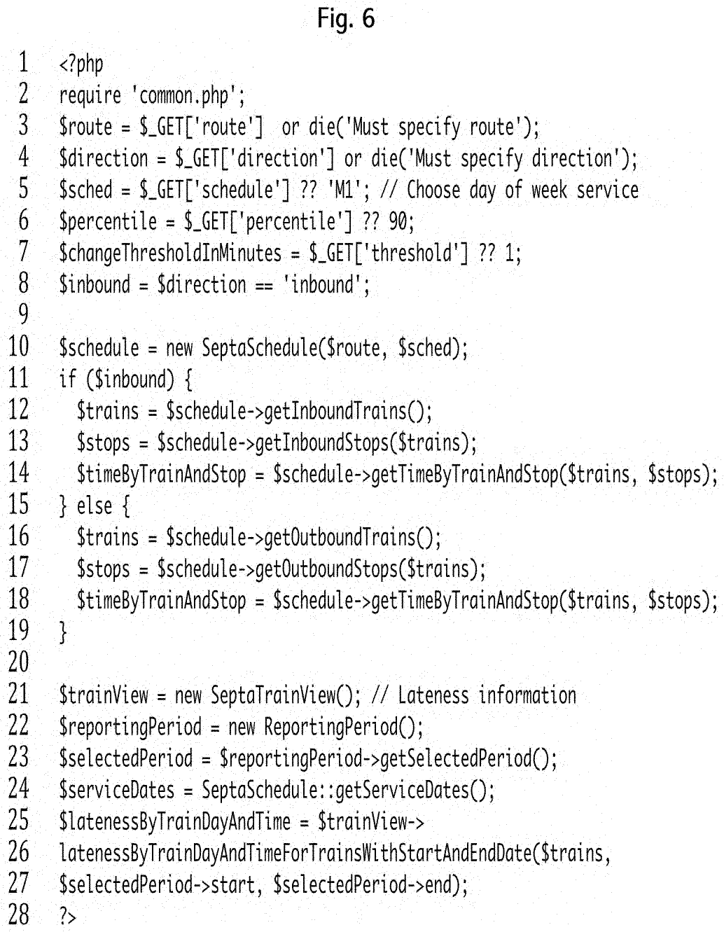

A second step includes determining a source and format of historical transit data comprising actual arrival times for routes and stops, and identifying any data retrieval protocol and conversion necessary to process that data. We refer to this as actual or real-time transit data and its associated retrieval protocol. The second step includes loading this real-time data retrieval protocol and conversion fixed schedule retrieval protocol into a monitoring processor. The second step includes executing this protocol and collecting the retrieved data for an analysis period, such as one year or another time period. A sample protocol is shown in FIGS. 6-8. Data may have to be retrieved frequently, such as every minute or 10 minutes, which may be called a data acquisition time interval. See claim 1(b) or 102 and 103 in FIG. 1. Note that the analysis period is shown as 107 in FIG. 1. For an exemplary quantity or data, consider an agency with 25 trains (train numbers), each with an average of 14 stops, that runs 365 days a year. This scenario generates 25*14*365=127,750 actual arrival times. Real-world schedules are more complex. For example, this scenario does not include various service types. Part of data retrieval, collection, and format conversion includes aggregation of various services; testing for errors, completeness, accuracy and integrity; accommodating for missing data; and observing any changes in an initial schedule.

Collection and analysis of data may be restricted to a subset of all data: a selected set. Typically, if a route or stop changes during the analysis period, that route and stop are deleted from the selected data set.

An exemplary scenario may be to scrape, acquire, collect or download data from a web site or RSS feed, for a train transit district in one city, for 100 trains (“routes,” “train numbers,” or “transit number”), for 50 stops, for a period of one year.

A third step is to sort the acquired data, typically in ascending order of lateness (time), for each stop of each route: a sorted subset. Subsets may be additionally or alternatively sorted based on service. Subsets may be sored in ascending (or descending) time order. Subsets may be compressed prior to, during, or after sorting. For example, for each minute late, only a count is maintained. Data may be kept in a list, table, database, array, hash table, data structure, (OOP) object or other format known in the art such as GTFS. See claim 1(c) or 104 in FIG. 1.

A fourth step is to select a proposed arrival time, for each subset (e.g., each stop on each route), such that a predetermined percentage of actual arrival times are less than or equal to the proposed arrival time. For example, if 250 arrival times are in one sorted subset, and the desire is that 90% of trains arrive on time (under the new schedule), then a cutoff in the sorted list would be at or about the 225^{th} entry. See claim 1(d) or 105 in FIG. 1. Note than an actual time may be one entry higher or lower in the list, or between two elements in the list. Rounding may be used, to pick a nearest minute, for example.

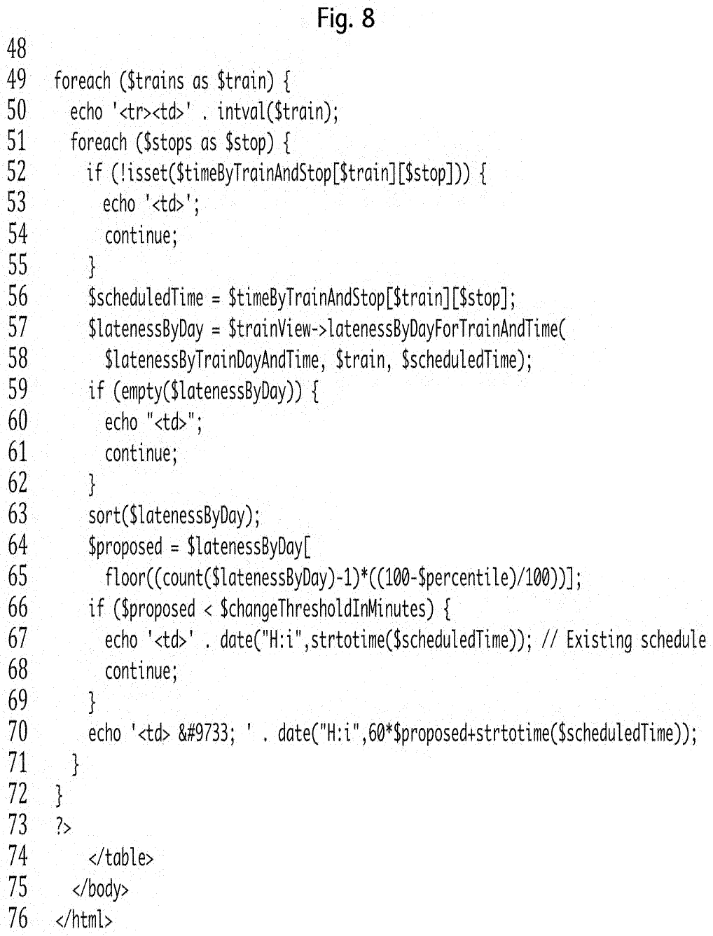

A fifth step is then computing a proposed time offset, by subtracting the initial scheduled arrival time from the proposed arrival time. This is, in essence, an, “expected late time,” if using the initial, fixed schedule. See claim 1(e) or 105 in FIG. 1 or lines 64-65 in FIG. 8.

A new timetable or schedule is created using the proposed arrival times for each subset, or each selected route and stop. However, a key element is to first compare the proposed time offset to a predetermined time threshold. If the propose arrival time differs from the initial fixed scheduled time, then the initial fixed scheduled time is still used for the arrival time in the new timetable or schedule. A benefit of this element of a method is minimal changes to a previous schedule that was well known. It may also permit easier memorization, such as, “trains arrive every 20 minutes after the hour,” even if that is true for only some of the trains. Exemplary time thresholds may be one minute for busses, two minutes for trains, and five minutes for airplanes. See claim 1(f) or 106 in FIG. 1, or line 70 in FIG. 8.

The new, or final, computed timetable or schedule of embodiments is then published or available, on paper or electronically, as described above for initial schedules. It may then be displayed on electronic signage, used by apps, such as navigation, travel apps, social networks, and scheduling apps, such as reminder or calendar apps, which may use this data to create or modify a time-to-leave, for example. See claim 1(f) or 106 in FIG. 1, or html output shown in FIG. 8.

An alternative embodiment uses a statistical model of the collected actual arrival times. Such a model might be a standard distribution: a Gaussian distribution, or may be an asymmetric distribution, such as one that includes skew or kurtoses, or one that includes an exponential decay. Fitting data to such a statistical model may include compute a best mean, skew and/or kurtoses, or computing using one or more predetermined skews or kurtoses, or computing a exponential decay time constant. Another alternative embodiment includes creating such a statistical model using more than one subset. For example, subsets may be grouped by route, by stop, by service, by day of week, or another grouping. Such groupings have the advantage of many more data points for fitting. A predetermined transit distribution model may be used. Selecting a cutoff is similar. Again a target on-time arrival percentage is used, and from the curve-fit distribution a proposed time-offset is computed. For example, for a Gaussian distribution shape, at two sigma about 97.7 percent of trains would have arrived on time.

Yet another embodiment provides a range of times. Typically such a range is provided for either or both departures and arrivals. For this embodiment, two proposed arrival time are used based on two predetermined percentages such as 10% and 90%. The predetermined time threshold may be applied to only one or to both the times in the proposed range.

Yet more alternative embodiments include information on cancellation probabilities and route or stop alternatives. For example, a route may be cancelled 5% of the time, or a stop might be skipped 10% of the time. These probabilities may be included in the final timetable or schedule.

If a “cutoff” late time is not desired, or is zero, the fifth step and comparison step to a predetermined time threshold may not be used. Rounding or truncation to a nearest minute or five minutes, for example, may be used, where rounding or truncation may be upward or downward.

Yet another embodiment applies these methods to non-scheduled trips, such as car or bicycle rentals, or on-request transit. For these embodiments, rather than transit numbers, trips are broken into units of time, such as every half hour or 15 minutes. Subsets may be organized by source and destination regions, such as from an airport to a particular zip code, as well as by time of day, day of week, and the like.

Although individual steps of embodiments may or may not involve well understood, conventional and routine automated activities, the particular combination of steps generates a novel result: a more accurate transit schedule. Embodiments may be viewed as transforming a historical transit performance into an accurate future fixed schedule.

There is an industry-standard format of encoding schedules into electronic data, known as, “Google Generated Transit Feed Specification,” or “General Transit Feed Specification,” or GTFS. In this specification, a stop comprises a location, a route number, and a service. A “route” may be a bus number (or name) a train number, a flight number. We refer to these also as transit numbers. The term, “stop,” may thus include more information than just a location. GTFS may be a static block of data, may be or include streaming data, and may be or include retrievable data.

The term, “service,” varies by transit type, agency, and routes. It may include, as non-limiting examples, maximum passenger count, seating and service level options (e.g., “first class,”), inbound or outbound direction, type of equipment, speed limits or speed limit zones, construction activity, ridership levels or type (e.g., bicycles), track sharing, unions or union rules, local jurisdictional rules (e.g., “no train horns”), connecting services, other related passenger services (e.g., rental cars), related parking, associated public events (e.g., ball games) and transit agency or jurisdiction. Any combination of services may be included in selecting, isolating, sorting or computing data subsets. Any combination of services may be included or indicated in a final timetable or schedule.

Turning now to FIG. 2, we see a portion of a typical timetable. Service types and route numbers are not shown. Typical captions are not shown, such as a train or bus number, in-bound or out-bound, AM or PM. Such a tabular structure is transitional for busses and trains. Airline flights typically use a different display format. Structurally, such a table could be either a previous fixed timetable such as used as input in step 101, or could be an output from step 106 in FIG. 1.

FIG. 2 may be a portion of a final output from an embodiment. Note, for example, that at Eastwick most trains arrive at 10 or 40 minutes after the hour. However, the 7:40 train, which used to frequently arrive late, is now scheduled to arrive at 7:44, a time at which 90% of trains now arrive on time.

FIG. 3 shows a portion of a more realistic real timetable, with left-to-right sequential columns being stops, and horizontal rows being train or bus routes. Note that automatically extracting digital data from such a schedule is challenging.

FIG. 4 shows a small portion of a web site for a transit agency. Typically, a series of hierarchical clicks are needed by users to drill down to a specific arrival time at a specific stop for a specific route. Often, day of week or holidays may have to be considered, either automatically by the web site or manually by a user. Data may be in the form of text, links, images, PDF files, spreadsheets, or any of numerous other electronic formats, all of which ultimately display information in human-readable form.

The challenge in automating the scraping or automatic collection of data from such web sites is significant. The software may have locate a link, then “click on” the link, then parse another page, find a link or data on that page, then extract an actual arrival time. Changes to web page design, interference from announcements, or ads must be considered.

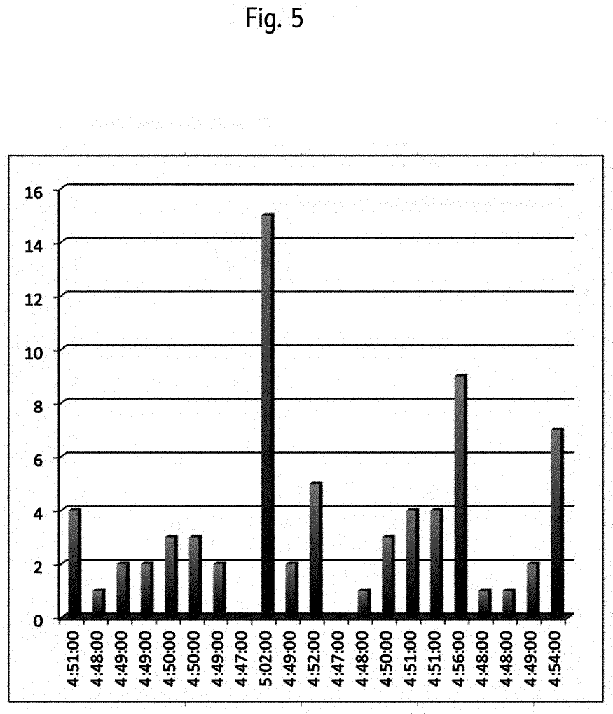

FIG. 5 shows a simple chart of arrival times for one stop on one route. This chart represents 21 days of data collection, and so has 21 times, shown on the x-axis, with a number of minutes late on the vertical axes. The number of minutes late varies from zero (if the train arrived at 4:45:00) to 15 minutes late. These times could be placed in a list of 21 elements and sorted from 0 minutes to 15 minutes. A 90% threshold would be at between elements 19 and 20 in the list. This would a late time between 7 minutes and 9 minutes, such as 8 minutes. Changing a planned arrival time on the previous timetable from 4:47:00 to 4:55:00 would accomplish the goal of having 90% of trains arrive on time. Note that 21 days is a shorter analysis period than is preferred. In some applications a different threshold may be desirable. For example, increasing the scheduled arrival time by only four minutes (to 4:51:00) would have only 80% of the trains arrive on time, but then about half of all trains would arrive within two minutes of the new arrival time. Such a time might be appropriate to publish as a “typical” arrival time. In another embodiment a range of times may be published, such as from 4:49:00 to 4:55:00. This range would permit people have a feel for how consistent arrivals times are.

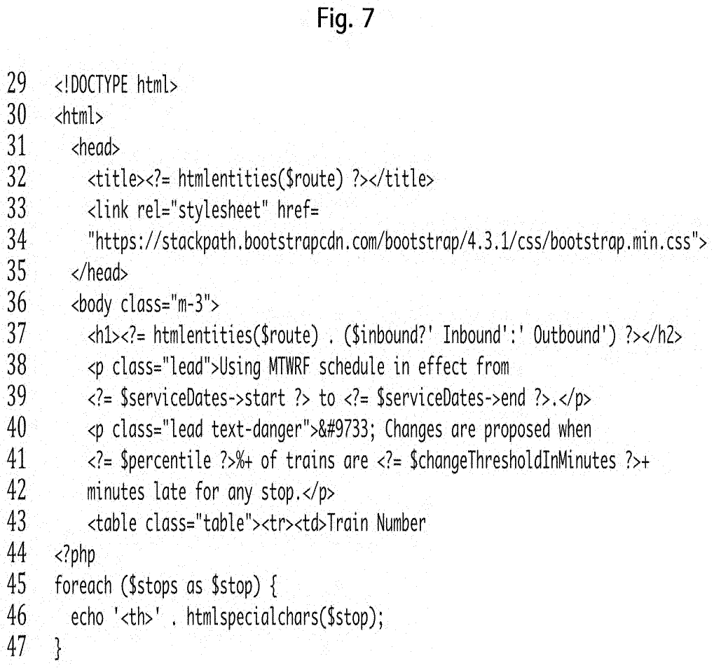

FIGS. 6, 7 and 8 show three pages of php code and html/css that implements an embodiment for a real transit agency. As variable names, including object and method names, are well named, an average person in the art (e.g., an experiences programmer who knows php and html), would be able to easily understand, implement, use and modify this code. We will not detail line-by-line functionality of the code, but will offer a few comments below to aid in understanding for those in the art. FIG. 6 creates the objects necessary to hold train, routes, times and related data. FIGS. 7-8 create an html document that contains a proposed schedule.

Line 12 is exemplary for collecting the initial timetable.

Line 21 is exemplary for scraping real-time data, kept in “$trainView.”

Lines 25-27 are exemplary for copying and converting.

Line 63 is exemplary for sorting arrival times.

Line 64-65 is exemplary selecting a proposed arrival time.

Line 66-68 is exemplary for applying a performance threshold to create a proposed time offset.

Line 70 is exemplary for applying a change threshold.

Line 70 is exemplary for output a new, proposed schedule.

Data structures are indeed, “structures.” Appropriate data structures include GTFS and its contents. Data may be kept in objects, such as used by an OOP (‘Object oriented programming”) language, such as php. Data may be stored in lists, arrays, a table, or a database (which may in tabular format, such as in FIGS. 2 and 3), for example. Data formats might be a spreadsheet, or CSV (“comma separated values”). As discussed previously, individual data elements, such as a stop name and stop time, may be numbers, strings, or special data formats such as a “date” or “time.”

### Improvements Over from Prior Art

Reference D1, “Harker,” U.S. Pat. No. 5,177,684 is in the field of train scheduling. The problem Harker is trying to solve is to keep trains from colliding when at least one train is off its planned schedule. Because track, switches and stations are usually shared among multiple trains, one late train will often delay other trains. Harker uses a physical system model, plus real-time data to warn human operators when trains and switches must be re-directed to avoid collisions. Harker uses neither historical arrival times nor does he produce a new, revised, fixed schedule. His invention is directed to individual incidents and involves a human in the process.

In reference D2, “Roulland,” publication US 2017/0169373 A1, Roulland collects historical data, however his only goal and output is to compute a “cost,” which he calls a “metric.” He merely “evaluates reliability,” but does not generate a new, fixed schedule for a route. His “cost” includes: “a perceived waiting cost, a cost of lateness at a final destination, a difference between scheduled arrival time and an actual arrival time, and an annoyance cost,” [abstract]. His invention may be used to assess an overall “performance” of a transit agency but cannot be used, nor is it intended to be used, to generate an improved fixed schedule.

Ideal, Ideally, Optimum and Preferred—Use of the words, “ideal,” “ideally,” “optimum,” “optimum,” “should” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substation thereof to any and all other device claims, including all combinations of elements in device claims. Claims for devices and systems may be restricted to perform only the methods of embodiments or claims.

What is claimed is:

1. A method of creating a transit timetable comprising the steps:
(a) collecting an initial timetable comprising, for selected stops of selected routes of a transit agency, an each planned arrival time;
(b) scraping real-time transit data from a transit data web site, comprising an actual arrival time each of the selected stops for selected routes in the initial timetable, wherein the scraping occurs for a first analysis period;
(c) sorting actual arrival times from the real-time transit data to create a sorted list for each selected stop for each selected route in order of ascending lateness;
(d) selecting a proposed arrival time for each sorted list such that a predetermined percentage of actual arrival times in the sorted list are less than or equal to the proposed arrival time;
(e) subtracting the planned arrival time (from the initial timetable in step (a)) from the proposed arrival time, for each selected stop for each selected route, to generate a proposed time offset;
(f) creating a final timetable, comprising the proposed arrival time for each selected stop for each selected route, except when the proposed time offset is less than or equal to a predetermined time threshold, in which case the previous planned arrival time is used from step (a).

2. The method of claim 1 comprising the additional step:
modifying the final timetable for any arrival time for any selected stop for any selected route where the planned arrival time from step (a) changed during the first analysis period, in which case the latest planned arrival time is used.

3. The method of claim 1 wherein:
the predetermined percentage of actual arrival times is in the range of 90% to 98%, inclusive.

4. The method of claim 1 wherein:
the predetermined time threshold is in the range of 1 to 10 minutes, inclusive.

5. The method of claim 1 comprising the additional steps:
(g) selecting a second proposed arrival time for each sorted list such that a predetermined second percentage of actual arrival times in the list are less than or equal to the second proposed arrival time;
(h) adding to the final timetable the second proposed arrival time.

6. The method of claim 1 comprising the additional steps:
(i) dividing each sorted list is divided into separate monthly sorted lists, where each monthly sorted list comprises entries from only one calendar month;
(j) creating a final monthly timetable, comprising the proposed arrival time for each selected stop for each selected route for each calendar month in which data was collected in step (b) for that month, except when the proposed time offset is less than or equal to a predetermined time threshold, in which case the previous planned arrival time is used from step (a).

7. The method of claim 1 comprising the additional steps:
(k) dividing each sorted list is divided into seven separate daily lists, where each daily sorted list comprises entries from only one day of the week;
(l) creating a final daily timetable, comprising the proposed arrival time for each selected stop for each selected route for each day of the week in which data was collected in step (b) for that day, except when the proposed time offset is less than or equal to a predetermined time threshold, in which case the previous planned arrival time is used from step (a).

8. The method of claim 1 comprising the additional steps:
(m) scraping weather data from a real-time weather source;
(n) classifying weather data into one class of a predetermined set of classes of weather;
(o) associated the weather class for each selected stop for each selected route with the actual arrival times from step (c);
(p) dividing each sorted list is divided into separate weather lists, where each weather list comprises entries from only one weather class;
(q) creating a weather timetable each day, comprising the proposed arrival time for each selected stop for each selected route when the class of a predicted weather for that selected stop matches the weather class of the corresponding weather list.

9. A method of creating a timetable comprising the steps:
(r) collecting an initial timetable comprising, for selected stops of selected routes of a transit agency, an each planned arrival time;
(s) scraping real-time transit data from a transit data web site, comprising actual arrival times for the selected stops for the selected routes in the initial timetable, wherein the scraping occurs for a first analysis period;
(t) copying the initial timetable to an intermediate timetable;
(u) modifying the intermediate timetable, responsive to the collecting and scraping, by adding, for each selected stop for each selected route, a proposed arrival time, wherein the proposed arrival time is such that a predetermined first percentage of the selected routes would have arrived by the proposed arrival time;
(v) creating a final timetable, responsive the intermediate timetable, wherein a final arrival times for each selected stop for each selected route comprises the proposed arrival time when the proposed arrival time is more than a predetermined time threshold than the planned arrival time, otherwise the final arrival time is the planned arrival time;
(w) publishing the final timetable.
